(19) United States
(12) Patent Application Publication
(10) Pub. No.: US 2004/0078245 A1
(43) Pub. Date: Apr. 22, 2004

(54) Pest control insurance system

(76) Inventor: Allen G. Harris, Sarasota, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/289,859

(22) Filed: Nov. 7, 2002

Related U.S. Application Data
(60) Provisional application No. 60/384,224, filed on May 30, 2002.

(51) Int. Cl. G06F 17/60

(52) U.S. Cl. 705/4

(57) ABSTRACT

A pest control insurance system includes a first step of inspecting a structure to locate a pest that is infesting the structure; the first pest belonging to a category of pests. In a second step, the pest is removed from the structure. In a third step, the owner/operator of the structure is provided with an insurance policy against an infestation of the structure. The insurance policy can provide for the removal of any pest selected from a category of pests following an infestation (including reinfestation) of the structure. In a fourth step, the structure is reinspected to locate any pests (belonging to the category of pests) that are infesting the structure. In a fifth step, the pests are removed from the structure.

### RELATED APPLICATION

This application claims priority of U.S. Provisional Patent Application 60/384,224 filed May 30, 2002, which is incorporated herein by reference.

### BACKGROUND OF THE INVENTION

1. Field of the Invention

The present invention is directed to an insurance system for pest control. More specifically, the present invention concerns a system of inspections and insurance for use in pest management and control.

2. Reference to Related Art

The removal of pests from structures is a necessary service in modern society. The number of potential pests that can invade a structure is incalculable. However, typical examples of a structural pest infestation range from the presence of single housefly to the invasion of a family of raccoons. The failure to remove such pests will in minor instances result in an unclean environment and in significant cases result in the deterioration of the infested structure.

The prior art includes a number of methods directed to insurance systems. Two notable examples are the TimberSafe and TimberSure termite warranty programs previously offered (now discontinued) by FAI Insurance in Australia. The first step in either the TimberSafe or the TimberSure program is an inspection of the structure (e.g., the insured's home) by an approved termite inspector. If the inspection finds no evidence of termites, then the insured will qualify for a TimberSafe warranty. Conversely, if the inspection does find evidence of termites, the insured can obtain a TimberSure warranty. Under the TimberSafe warranty, if termites enter the structure within the twelve months following the inspection, the insured is covered for any extermination treatments necessary to remove the termites as well as the repair of any damage caused by the termites. Under the TimberSure program, the insured must first accept (i.e., pay for) any termite treatment recommendations made by the inspector to remove the termite infestation. Thereafter, the insured is protected for a renewable twelve-month period against damage to structural timbers, decorative timbers and furnishings.

Various other systems related to providing insurance against risk are disclosed in the prior art. For example, U.S. Pat. No. 5,608,658 discloses a system wherein product units are inspected before they are supplied to customers with insurance. In this system, product units are inspected for possible defects and any unit identified as being defective is repaired.

Another example is U.S. Pat. No. 5,842,148, which discloses a method for evaluating wooden residential structures in order to determine the amount of damage an earthquake or wind will cause to those structures. The '148 system focuses on the use of a software engine that combines various data sets and produces a risk rating for the wooden structure that can be used by insurance companies to make decisions concerning insurance rates.

Finally, U.S. Pat. No. 6,338,040 discloses an insurance method for protecting the financial interest of farmers planting transgenic seeds. In this system, the sale of insurance against pest-related crop damage is used as an incentive for long-term crop management.

The prior art does not disclose an insurance system for use in the management and control of a variety of pests. Pests such as termites, mice and bats are a common problem in many residential, commercial and industrial structures. Therefore, it would be advantageous to have a system that promotes the inspection and removal of those and other pests.

### SUMMARY OF THE INVENTION

The present invention is directed to a renewable pest control insurance system that allows the owner or operator of a structure to obtain insurance against the infestation and damage caused by a wide array of pests. The system includes a first step of inspecting a structure to locate a pest (i.e., a first pest) that is infesting the structure. The structure can be a residential, commercial or industrial property. Furthermore, the pest to be located can belong to an entire category or categories of pests. In a second step, the pest located during the inspection is removed from the structure. In a third step, the owner or operator of the structure is provided an insurance policy against an infestation of the structure by a pest. The insurance policy can provide coverage against an infestation by the specific pest previously removed from the structure, a different pest not previously found in the structure or an entire category or categories of pests. In a fourth step, following a lapse of a predetermined period of time, the structure is reinspected to learn if a pest is infesting the structure and, if necessary to locate that pest. This second pest can be the same as the first pest or an entirely different pest. These second pests may also belong to the same category of pests as the first pest. The predetermined period of time can be established by the insurer or the insured and can vary depending upon the type of pest located during the inspection of the first step. Therefore, it will be appreciated that time periods of three, six or twelve months between the inspection and reinspection steps can be used in connection with the insurance policy. Finally, in a fifth step the second pest (if located in the fourth step) is removed from the structure.

### BRIEF DESCRIPTION OF THE DRAWINGS

A better understanding of the invention will be had upon reference to the attached drawing wherein like reference numerals refer to like parts throughout and wherein:

FIG. 1 is a schematic view showing the method of the present invention.

### DETAILED DESCRIPTION

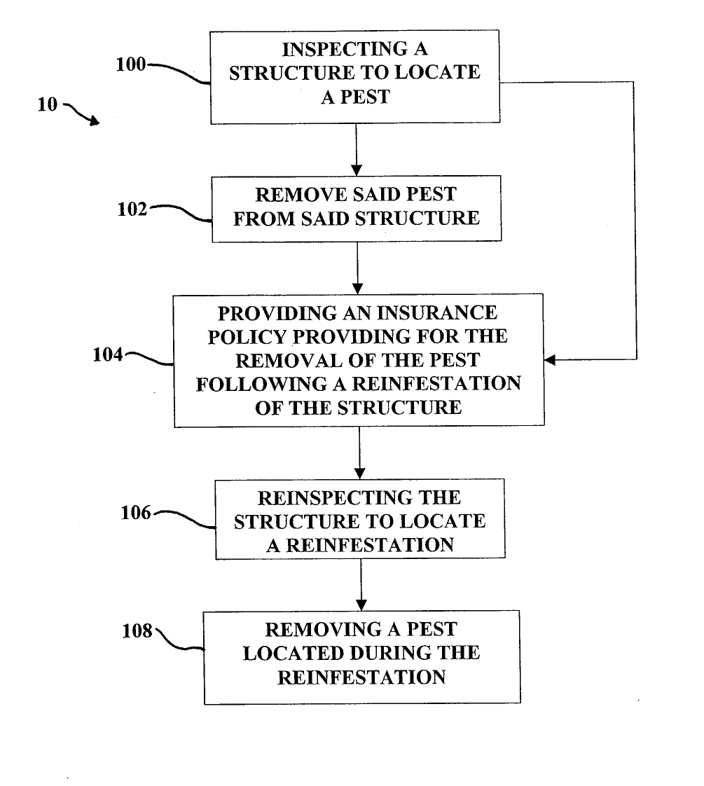

Referring now to FIG. 1, the pest control insurance system 100 of the present invention includes a first step 102 of inspecting a structure; a second step 104 of removing a pest located during the inspection; a third step 106 of providing an insurance policy against an infestation of the structure by a pest; a fourth step 108 of reinspecting the structure to locate a new infestation; and a fifth step 110 of removing a pest following the reinspection.

Of particular importance to the present invention is the aspect of providing insurance before treatment is needed. Therefore, preferably, in the first step 102 of the system 100 of the present invention, an inspection is undertaken of a structure that may or may not have a pest infestation. As used herein, the term “structure” is intended to mean a residential, commercial (including educational) or industrial building including the surrounding grounds (lawn, trees, etc.). Furthermore, the term “pest” is intended to mean most any insect or other non-human creature that can cause damage to the structure or irritation to the occupants of the structure. By way of example, pests include, but are not limited to, all varieties of subterranean and Formosan sub termites, West Indian dry wood termites, beetles (e.g., powderpost, deathwatch, false powderpost, furniture and timber beetles), borers (e.g., new house borers, dark, longhorn and old house borers), ants, cockroaches, box elders, centipedes, crickets, earwigs, bees, elm leaf beetles, spiders, ticks, wasps, fire bats, fleas, moths, rodents, snakes, flies, raccoons, bob cats, alligators, birds and bats. During the inspection, an inspector (the term inspector includes exterminator) reviews and evaluates the structure using methods and techniques known in the art to determine the presence and severity of a pest infestation.

In a second step 104, the inspector undertakes measures such as trapping, poisoning or other measures well known in the art to remove the pest infestation. It will be appreciated that where the inspection of first step 102 fails to disclose any pest infestation, the second step 104 will not be required.

In a third step 106, the owner or operator of the structure receives, preferably for a fee, an insurance policy against an infestation (including reinfestation) and/or structural damages caused by the removed pest. The policy may also provide cover against any other type or category of pest not disclosed during the inspection. Alternatively, where the inspection of the first step 102 failed to disclose a pest infestation, the owner or operator of the structure can, preferably for a fee, receive an insurance policy against future infestations and/or structural damage caused by a particular type or category of pest.

After receiving the insurance policy, if the owner or operator of the structure reports a reinfestation by a pest previously removed from the structure (i.e., the first pest) or a new infestation by a different pest (i.e., a second pest) identified in the policy, the owner or operator will be entitled to free removal of the pest. Additionally, where the pest infestation has resulted in damage to the structure, the owner or operator will (provided he or she is covered for such damage under the policy) be entitled to compensation, repair or replacement of or for the damage.

It will be appreciated that the insurance policy of the present invention may also offer protection against infestation against a whole category of pests. For example, in one embodiment the insurance policy may be directed to cover only damage caused by wood eating insects. In another embodiment, the insurance policy may be directed to cover only structure pest control, excluding wood eating insects (wasps, bees, etc.). In a still further embodiment, the insurance policy may be directed to cover only the trapping of animal pests (e.g., birds, bats, moles, wild pigs, armadillos).

Preferably, the insurance policy will extend coverage against future infestations by a pest identified in the policy for a renewable, yet limited period of time (e.g., six months to a year).

In a fourth step 108, prior to the termination of the limited time period for the insurance policy, the owner or operator of the structure will seek to renew the insurance policy on the structure against a pest infestation by requesting a new inspection. Alternatively, the reinspection will occur at the request of the insured to enforce the insurance policy following a reinfestation of the structure. Preferably, the reinspection is carried out in a manner similar to the inspection of the first step 102.

As a further alternative, in a fifth step 110, any pests located during the re-inspection and named in the insurance policy are removed at no cost to the insured. As with the second step 104, the removal of the pest(s) is preferably carried using methods and techniques known in the art. Furthermore, it will be appreciated that where the inspection of fourth step 108 failed to disclose any pest infestation, the fifth step 110 will not be required.

Having thus described my invention, various alternative embodiments will be apparent to those having skill in the art that do not depart from the scope of the present invention.

1. A pest control insurance system comprising the steps of:
inspecting a structure to locate a first pest that is infesting said structure, said first pest belonging to a category of pests;
removing said first pest from said structure;
providing an insurance policy against an infestation of said structure by a pest belonging to said category of pests, said insurance policy providing for the removal of a pest selected from said category of pests following a infestation of said structure;
reinspecting said structure to locate a second pest that is infesting said structure, said second pest belonging to said category of pests; and
removing said second pest from said structure.

2. The pest control insurance system of claim 1 wherein said structure comprises a residential property.

3. The pest control insurance system of claim 1 wherein said structure comprises a commercial property.

4. The pest control insurance system of claim 1 wherein said structure comprises an industrial property.

5. The pest control insurance system of claim 1 wherein said category of pests comprises a wood eating insect.

6. The pest control insurance system of claim 5, wherein said wood eating insect is selected from the group consisting of: termites, beetles or borers.

7. The pest control insurance system of claim 1 wherein said category of pests is selected from the group consisting of ants, cockroaches, box elder centipedes, crickets, earwigs, elm leaf beetles, bees, spiders, flies, ticks, wasps, killer bees, yellow-jackets, firebrats, fleas, millipedes, pillbugs, silverfish, sawbugs, carpet beetles, pantry pests, grain beetles and Indian meal moths.

8. The pest control insurance system of claim 1 wherein said category of pests is selected from the group consisting of: ants, cockroaches, box elder centipedes, crickets, earwigs, elm leaf beetles, bees, spiders, ticks, wasps, killer bees, yellow-jackets, firebrats, fleas, millipedes, pillbugs, silverfish, sawbugs, carpet beetles, pantry pests, grain beetles and Indian meal moths, rodents and snakes.

9. The pest control insurance system of claim 1 wherein said category of pests comprises non-human mammals.

10. The pest control insurance system of claim 1 wherein said category of pests is selected from the group consisting of: rats, mice, squirrels, raccoons, opossums, moles, Florida panthers, bobcats, wild pigs, alligators, groundhogs, armadillos, snakes, birds and bats.

11. The pest control insurance system of claim 1 wherein said category of pests comprises a lawn and ornamental insect.

12. A pest control insurance system comprising the steps of:
inspecting a structure to locate a pest that is infesting said structure;
removing said pest from said structure;
providing an insurance policy against an infestation by said pest, said insurance policy mandating the removal of said pest following an infestation by said pest of said structure;
reinspecting said structure to locate an infestation by said pest; and
removing said pest from said structure following said reinspection.

13. The pest control insurance system of claim 12 wherein said step of reinspecting said structure occurs a predetermined period of time after said step of inspecting said structure.

14. The pest control insurance system of claim 12 wherein said predetermined period of time is at least three months.

15. The pest control insurance system of claim 12 wherein said predetermined period of time is at least six months.

16. The pest control insurance system of claim 12 wherein said predetermined period of time is at least twelve months.

17. The pest control insurance system of claim 12 wherein said pest is selected from the group consisting of: wood eating insects, non-wood eating insects, rodents, reptiles, birds, bats or non-human mammals.

18. The pest control insurance system of claim 12 wherein said pest is selected from the group consisting of subterranean termites, Formosan sub termites, West Indian dry wood termites, powderpost beetles, deathwatch beetles, false powderpost beetles, furniture beetles, timber beetles, new house borers, dark borers, longhorn borers and old house borers, ants, cockroaches, box elders, centipedes, crickets, earwigs, bees, elm leaf beetles, spiders, ticks, wasps, fire bats, fleas, moths, rodents, snakes, flies, raccoons, bobcats, alligators, birds or bats.
